(19) United States
(12) Patent Application Publication
(10) Pub. No.: US 2006/0011752 A1
(43) Pub. Date: Jan. 19, 2006

(54) Agricultural, forestry and horticultural machine

(76) Inventor: Joris Hiddema, NB Blerick (NL)

Correspondence Address: DEERE & COMPANY, ONE JOHN DEERE PLACE, MOLINE, IL, 61265, US

(21) Appl. No.: 11/152,551

(22) Filed: Jun. 14, 2005

(30) Foreign Application Priority Data
Jun. 15, 2004 (DE) 10 2004 028 642.6

(51) Int. Cl. A01C 15/00

(52) U.S. Cl. 239/650

(57) ABSTRACT

Structure such as an agricultural, forestry or horticultural machine with a parallel bar linkage assembly (18) adjustably mounting an implement (20) such as a spray assembly for vertical movement relative to the ground. The linkage assembly includes a first and a second parallelogram (48, 50) having a first common link (30). A first portion (54) of the link (30) forms one side of the first parallelogram (48) and a second portion (58) of the link (30) forms one side of the second parallelogram (50). The two parallelograms (48, 50) save space and improve implement positioning and action radii as compared to conventional linkage constructions.

### FIELD OF THE INVENTION

The invention relates generally to implements such as agricultural, forestry and horticultural machines, and more specifically to such machines having parallel linkages.

### BACKGROUND OF THE INVENTION

Agricultural, forestry and horticultural machines are known which contain parallel linkages or bars for guiding and adjusting the height of tools such as sprayers. Such parallel bars are generally equipped with upper and lower pivoted connectors or links of equal length. The links are pivotally connected to a stationary member or rod, and a cylinder or servomotor actuates one of the pivoted links.

In DE 101 29 552 A1 an agricultural spreader is shown equipped with parallel bars with an upper and a lower link. The parallel bars are centered on the longitudinal axis of the spreader for moving a spreader rod or boom assembly up and down relative to a machine frame.

Another machine is revealed in the brochure of HARDI company (publication: GB/HIA 890351.9-01). Parallel bars are used on both sides of a drawn field sprayer for controlling a spraying boom assembly, with the parallel bars being equipped with upper and lower links of equal length that are both connected to a stationary member.

Such previously available parallel bar assemblies have the disadvantage of a significant overall height which leads to limitations with regard to the positioning of the bar assembly on the machine. An unfavorable displacement of the center of gravity of the machine, as well as small pivot angles of the links, result from the limitations. Positioning the bar assembly far behind a machine results in large swing-out radii. For these reasons the parallel bar assemblies shown have relatively short pivoting links, and consequently a relatively small swing-out radius which causes relatively large movements of the mounted implement connected to the parallel bar assembly during raising and lowering of the implement.

The challenge constituting the base of the invention is the design of a linkage for an agricultural, forestry or horticultural machine of the type stated above that would overcome the aforementioned problems.

### SUMMARY OF THE INVENTION

According to the invention an agricultural, forestry or horticultural machine of the type stated above is equipped with an assembly of parallel bars which comprise a first and a second parallelogram with a first common link. The first part of the link forms one side of the first parallelogram, and a second part of the link forms the adjacent side of the second parallelogram.

By utilizing two parallelograms, individual parallelograms can be designed with a reduced height thereby facilitating advantageous positioning of the assembly of parallel bars on the machine. The divided parallelogram configuration makes possible a common pivoting link with a relatively large swing-out radius, as compared with the state of the art, without need for substantial protrusion of assembly outside the boundaries of the machine. The structure provides better positioning of the center of gravity while allowing smaller horizontal movements with small swing-out radii.

For the first and second parallelogram, the assembly of parallel bars is also provided with a second common link or connecting arm structure. A first part of the second common link forms one side of the first parallelogram and a second part of the second common link forms another side of the second parallelogram. The common rods cross each other and share a common point of articulation. It is possible to divide the assembly of parallel bars into more than two parallelograms. Accordingly the assembly of parallel bars would be equipped with additional common links each belonging to two parallelograms.

By means of a stationary link located in the first parallelogram the assembly of parallel bars is connected to the machine, for instance through a weldment or screws, with a part of the frame of the machine. Preferably this stationary link is the link that is opposite to the second common link, while a stationary connection of the second common link with the machine would also be possible in order to fasten the parallel bars to the machine.

Preferably the first common link is swingably connected to the stationary link so that the second common link is displaced through a swinging movement of the first common link around a point of articulation located on the stationary link. In case of a stationary connection of the second common link with the machine, the swinging movement of the first common link would occur around the shared point of articulation, resulting in a displacement of the link located opposite to the second common link.

Preferably the swinging motion is caused by a cylinder or servomotor actuating the first common link and located between a stationary point on the machine, for instance on a part of the machine frame or at one of the stationary links and the first common link to be pivoted. The servomotor is pivotally connected between the link and the machine. In order to achieve better lever action or a more direct power transmission between the servomotor and the link, it is possible to provide the link or the machine with a link pan. That way the servomotor makes only small swinging movements around its points of articulation. The servomotor can be, for example, a hydraulic cylinder, an electrically powered spindle motor or an air motor. Manual operation of the assembly of parallel bars is also possible, in which case an appropriate latching device for one of the links is provided.

In the area of the second parallelogram, a link is connected to a mounted implement. This link, together with a part of the first and of the second common link and a link that is opposite to a part of the first link, forms the second parallelogram. By pivoting the first common link, the mounted implement can be raised or lowered while maintaining a predefined level of position.

In one embodiment of the invention, the machine is a vehicle with a frame and at least one axle. Preferably the assembly of parallel bars is arranged so that the axle will be situated between the stationary link and the mounted implement. This will allow advantages such as a favorable center of gravity of the mounted implement in relation to the vehicle and favorable lever ratios around the vehicle axle. The farther the stationary articulation is displaced behind the axle, the less the lever action around the vehicle axle. Little lever action around the vehicle axle results in smaller weight fluctuations on the vehicle and hence more constant vertical forces on a vehicle hitch coupling.

In another version of the invention, the assembly of parallel bars is arranged so that the vehicle axle is situated between the first parallelolgram and the mounted implement to increase the aforementioned advantages even further. The first parallelogram can be lowered below the axle level, and therefore the pivoting angle of the linkage assembly can be significantly increased, by comparison with traditional assemblies of parallel bars. Furthermore it is conceivable to arrange the assembly of parallel bars so that the first parallelogram beginning from the first common link extends upward while the second parallelogram accordingly extends downward. Depending on the vehicle configuration and operating characteristics, both variants may be advantageous, so that the extension of the first parallelogram may be made downward or upward, or the extension of the second parallelogram upward or downward respectively.

In one embodiment of the invention, the machine is either a tractor-drawn field or self-propelled sprayer. The machine may be a mounted sprayer attached to the three-point hitch of a tractor. In addition, a reaper with mowing equipment or a tillage implement with one or more sowing units, plows or the like can utilize the linkage assembly. Alternatively, a tractor or another self-propelled or tractor-drawn agricultural vehicle may be equipped with the linkage assembly. The assembly may be used for mounting any implement that is to be moved across the soil at variable heights or depths. In addition, numerous other design versions of agricultural, forestry and horticultural machines are possible which are easily apparent to an expert in light of the description and which fall under the present invention.

For example, in another design version, the machine is equipped with a sprayer or spreader assembly which is controlled by one or more linkage assemblies. The sprayer or spreader assembly is controlled by two parallel linkage assemblies of parallel bars spaced on opposite sides of the machine, and the assemblies of parallel bars are connected to each other through the sprayer assembly or a connecting frame. Alternatively, only one linkage assembly can be attached, preferably to the center of the machine for a sturdy construction.

In one version the mounted implement is preferably a sprayer assembly that can be adjusted to any predefined height above the ground as required for proper spraying of the plants. Alternatively, the mounted implement can be a spreader assembly, for instance for liquid fertilizer or the like. It is also conceivable to have a blower sprayer or a scattering device as the mounted implement.

In another design version, the machine is equipped with a tank that can serve as a storage container for spray liquid, for fertilizer, or for other material to be scattered such as seeds or the like. Preferably the tank is provided with recesses thereby expanding the operating space or radius of action of the linkage assembly so that the links can be pivoted over a greater pivoting angle. The tank can also be designed as a supporting structure so that no frame is required and all add-on pieces on the frame such as the running gear or the axle and the linkage assembly are mounted to the tank. Such design versions can be particularly useful for compact add-on sprayers that are connected directly to a three-point hitch of a tractor.

Further advantages may be had by locating the stationary link essentially below the tank to facilitate a large swing radii and a favorable position of the center of gravity of the linkage assembly and any ancillary equipment. Furthermore, the space available for the tank above the assembly, particularly above the first parallelogram, can be used in an optimal fashion to obtain the highest tank volume possible and to avoid costly recesses on the tank.

Preferably the linkage assembly is mounted for pivoting vertically relative to the ground and is thus able to ensure the vertical movement of ancillary equipment or an implement or other device. The linkage assembly may also be arranged for horizontal pivoting to allow the horizontal movement of ancillary equipment, implements or other devices at a constant height above the ground but at a variable distance from the machine. Such an arrangement is useful, for example, with a blower sprayer which allows spreading of a liquid in planting rows of various widths on both sides of the vehicle through adjustable discharge openings.

The drawings show a design example of the invention which is described and explained in greater detail along with further advantages and advantageous additional developments. Other objects, features and advantages of the present invention will become apparent from the following description and from the drawings.

### BRIEF DESCRIPTION OF THE DRAWINGS

FIG. 1 is a side view of an agricultural machine with an assembly of parallel bars according to the invention in raised position.

FIG. 2 is a view similar to FIG. 1 but with the assembly of parallel bars in a lowered position.

### DESCRIPTION OF THE PREFERRED EMBODIMENT

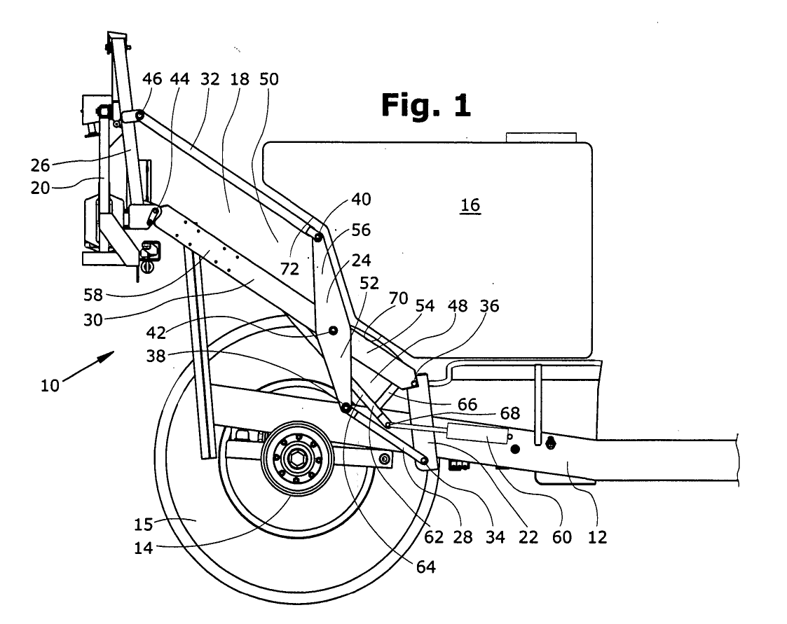

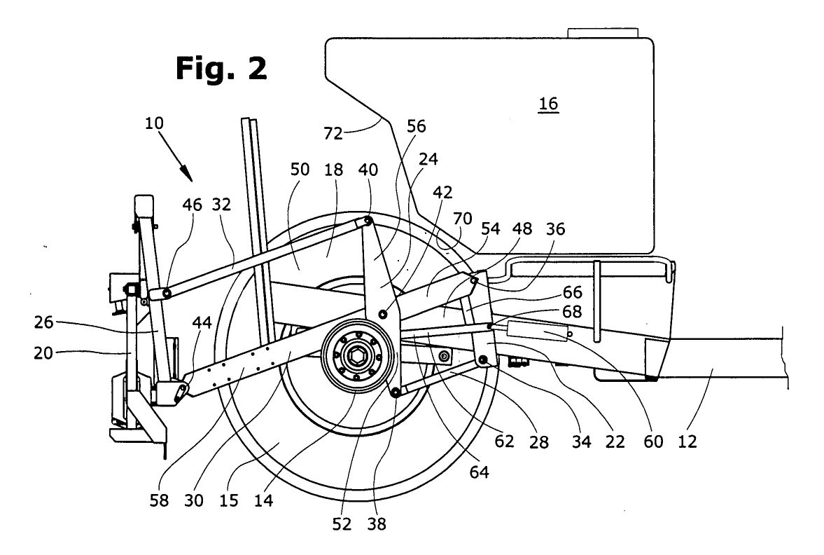

FIGS. 1 and 2 show an agricultural machine 10 in the form of a drawn agricultural sprayer. Although a sprayer is shown, other vehicles may be utilized. The machine 10 includes a frame 12 and an axle 14 with wheels 15 attached to a rear section of the frame 12. A hitch (not shown) may be used to connect the machine to a tractor, such as an agricultural tractor.

The machine 10 is further equipped with a tank 16 which serves as the storage container for the liquid to be sprayed. A linkage assembly or assembly of parallel bars 18 mounts an implement 20, shown in the figures as a sprayer assembly. The mounted implement 20 is connected via conduits (not shown) to the tank 16 which supplies the liquid to be sprayed.

The assembly of parallel bars or linkage assembly 18 includes a first, a second and a third upright or vertical link 22, 24, 26 and a fourth, a fifth and a sixth generally horizontal link 28, 30, 32. The first link 22 is connected to the fourth link 28 and the fifth link 30 by means of a lower and an upper pivot 34, 36. The second link 24 is connected to the fourth link 28 and the sixth link 32 by means of a lower and an upper pivot 38, 40 and also has a central point pivot 42 which connects the second link 24 with the fifth link 30, with the links 24, 30 crossing each other. The third link 26 is connected to the fifth link 30 and to the sixth link 30 respectively, by means of a lower and an upper pivot 44, 46. The connection of the links 22, 24, 26, 28, 30, 32 with each other as described above provides an assembly of parallel bars 18 defining a first parallelogram 48 and a second parallelogram 50. The first parallelogram 48 is formed by the opposing links 22 and 24, and 28 and 30 respectively, with a portion 52 of the second link 24 and a portion 54 of the fifth link 30 each forming one side of the first parallelogram 48. The second parallelogram 50 is formed by the opposing links 24 and 26 or 30 and 32 respectively, with a remaining portion 56 of the second link 24 and a remaining portion 58 of the fifth link each forming one side of the second parallelogram 50.

Links 22, 24, 26, 28, 30, 32 can be for example in the shape of flat bars, of angle irons or of pipes of varying thickness, depending on static and dynamic loads. In the design example shown in FIGS. 1 and 2 the first, second and fifth link 22, 24, 30 are in the form of flat bars because these links are exposed to greater static and dynamic loads than the fourth and sixth links 28, 32 which are made from pipes since they act only as reversing rods.

The central point of articulation 42 of the second link 24 connecting the second link 24 to the fifth link 30 is placed so that the portions 52, 56 of the second link 24 form portions of equal length and so that the portion 54 of the fifth link 30 is approximately half as long as the portion 58 of the fifth link 30. In accordance with the prerequisites for a parallelogram, the length of the fourth link 28 corresponds to the length of the portion 54 and the length of the sixth link corresponds to the length of the portion 58 of the fifth link 30. Further, the length of the third link 26 corresponds to the length of the portion 56 of the second link 24, implying for all of these the effective length, i.e., the length of a link 22, 24, 26, 28, 30, 32 and, respectively, the length of a portion 52, 54, 56, 58 which is produced between two points of articulation 34, 36, 38, 40, 42, 44, 46 of a link 22, 24, 26, 28, 30, 32 or of a portion 52, 54, 56, 58.

A servomotor 60 extends between the frame 12 and an articulated rod mechanism 62. The articulated rod mechanism 62 is rigidly connected with the fifth link 30 and serves to effect the actuating power of the servomotor 60 on the assembly of parallel bars 18. The articulated rod mechanism 62 is formed by two rods 64, 66 that are rigidly connected to the fifth link 30. The two rods 64, 66 form a triangle with the link 30 and provide a point of articulation for the servomotor 60. In an alternate design version, the articulated rod mechanism 62 may be a triangular piece of sheet metal which is welded on one of its edges to the link 30. The servomotor 60 is shown as a hydraulic cylinder and is controlled by a hydraulic control (not shown) for the purpose of raising and lowering the linkage assembly 18.

The first link 22 is rigidly attached to the frame 12, whereas the remaining links 24, 26, 28, 30, 32 are connected to each other in the manner described above and can be pivoted pivotal axes at the points 34, 36, 38, 40, 42, 44, 46. The third link 26 is attached to the mounted implement 20. By extending and retracting the servomotor 60, the fifth link 30 is pivoted and the linkage assembly 18 is raised and lowered around the points 34, 36. Because the links 22, 24, 26, 28, 30, 32, and the portions 52, 54, 56, 58 are equal length, the mounted implement 20 is always raised or lowered in a position that is constantly parallel to the ground.

The attachment of the first link 22 as shown is below the tank 16 and in the direction of the hitch of the machine in front of the axle arrangement 14. The attachment of the first link 22 on the frame 12 has been selected so that the first parallelogram can be completely lowered between the axle arrangement 14 and the first link 22 so as to obtain the position shown in FIG. 2 of the assembly of parallel bars 18 and so that the portion 52 of the second link 24 will be lowered or pivoted, until it is directly in front of the axle 14. The space savings provided by the linkage assembly 18 facilitates installation of a larger tank 16 than would be possible with most prior art structures. The tank 16 as shown is shaped so that recesses 70, 72 are provided that conform to the path of the linkage assembly 18 to optimize use of the saved space generated by dividing the assembly 18 into two parallelograms 48, 50. A first link 22, appropriately positioned far forward on the frame 12 ahead of the axle 14 and consequently a long fifth link 30, have a positive effect on the location of the center of gravity of the machine 10. In addition, the linkage structure arrangement has positive effect on horizontal displacement of the mounted implement 20 during raising and lowering of the assembly 18.

Preferably the agricultural machine shown in FIGS. 1 and 2 includes linkage assemblies 18 on both sides of the vehicle connected to each other by an appropriate cross-tie (not shown) at the third link 26. For example, a cross strut or a connecting frame may be connected between the third links 26 of the spaced assemblies 18.

1. Agricultural, forestry and horticultural machine with an assembly of parallel bars (18) comprising a first and a second parallelogram (48, 50) with a first common link (30) where a first portion (54) of the first common link (30) forms one side of the first parallelogram (48) and a second portion (58) of the first common link (30) forms one side of the second parallelogram (50).

2. The machine as set forth in claim 1, wherein the first and second parallelogram (48, 50) include a second common link (24), wherein a first portion (52) of the second common link (24) forms another side of the first parallelogram (48), and a second portion (56) of the second common link (24) forms another side of the second parallelogram (50), and wherein the common links (24, 30) cross each other and form a common point of articulation (42).

3. The machine as set forth in claim 1, wherein the first parallelogram (48) includes a stationary link (22).

4. The machine as set forth in claim 3, wherein the first common link (30) is pivoted around the stationary link (22).

5. The machine as set forth in claim 1 including a servomotor (60) connected to and actuating the first common link (30).

6. The machine as set forth in claim 1 wherein the second parallelogram (50) includes a link (26) attached to a mounted implement (20).

7. The machine as set forth in claim 3 including a frame (12) and at least one axle (14), the axle located between the stationary link (22) and the mounted implement (20).

8. The machine as set forth in claim 1 including a mounted implement (20) and a vehicle axle (14) located between the first parallelogram (48) and the mounted implement (20).

9. The machine as set forth in claim 1 wherein the machine (10) is a sprayer.

10. The machine as set forth in claim 8 wherein the mounted implement (20) is a spray assembly.

11. The machine as set forth in claim 1 wherein the machine (10) supports a tank (16), the tank having recesses (70, 72) defining an open action space for the assembly of parallel bars (18).

12. The machine as set forth in claim 3, further including a tank (16) and wherein the stationary link (22) is located below the tank (16) on the machine (10).

13. The machine as set forth in claim 1 wherein the assembly of parallel bars (18) pivots in an upright direction relative to the ground surface.
